(19) United States
(12) Patent Application Publication
(10) Pub. No.: US 2008/0198754 A1
(43) Pub. Date: Aug. 21, 2008

(54) Method and system for testing a communication network

(75) Inventors: Raghvendra Savoor, Walnut Creek, CA (US); Tomoko Convis, Danville, CA (US); Zhi Li, San Ramon, CA (US); Sun-uk Park, Union City, CA (US); Bruce Alden Schine, San Leandro, CA (US); Xiaochuan Yi, Pleasanton, CA (US); Haibo Zhang, San Jose, CA (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/708,646

(22) Filed: Feb. 20, 2007

(51) Int. Cl. H04L 12/26

(52) U.S. Cl. 370/245; 370/389

(57) ABSTRACT

A multicast test of an Internet Protocol (IP) network is performed with an initial multicast probing frequency. The multicast probing frequency of the multicast test is increased, and an impairment of the IP network based on the multicast test is detected based on the multicast test. Based on detecting the impairment, a unicast test is performed at one or more segments of the IP network. Based on the unicast test, an impaired segment of the IP network is identified.

### FIELD OF THE DISCLOSURE

The present disclosure is generally related to testing communications networks.

### BACKGROUND

Broadband service providers have gradually transformed from pure data service providers to Internet Protocol (IP)-based content providers (e.g. data, voice and video service providers). Providing IP-based video delivery services has attracted interest because of its inherent flexibility in providing both a large number of channels and advanced features.

However, video delivery via an IP network poses challenges to service providers. Video services have higher quality-of-service (QoS) requirements than data and voice services. For example, video services can tolerate less packet loss, smaller end-to-end jitter and latencies than data and voice services. Guaranteeing the end-to-end QoS desired for providing video services in an IP network is more difficult than for providing the video services via either a circuit-switch based network, an asynchronous transfer mode (ATM) network, or a cable television (CATV) network. Potential causes of video service degradation include network congestion, routing disruption, misconfiguration, and video digital subscriber line (VDSL) loop performance degradation.

### BRIEF DESCRIPTION OF THE DRAWINGS

FIG. 1 is a block diagram of a system for determining delivery path performance in an IP network used to deliver an IP-based video service;

FIG. 2 is a block diagram of an embodiment of placement of the IP-based probes in an embodiment of the IP network;

FIG. 3 is a flow chart of an embodiment of a method of testing the IP network using multicast and unicast tests;

FIG. 4 is a flow chart of an embodiment of a method of performing trouble isolation based on probing results; and

FIG. 5 is a block diagram of an illustrative embodiment of a general computer system.

### DETAILED DESCRIPTION OF THE DRAWINGS

Disclosed herein are embodiments of methods and systems for a video service provider to perform video impairment root-cause analyses and trouble isolation. The embodiments include a method to select an appropriate probe type and location for IP-based probe placement, a self-learning method to optimize IP-based probes, and a systematic method to perform trouble isolation and correlation. The embodiments can be used by Internet Protocol (IP)-based video service providers, such as IP-television (IPTV) providers, to efficiently deploy, utilize and correlate a network-based probing mechanism to quickly locate and identify network segments having an undesired performance. The embodiments can reduce a cost to operate an IP-based video service, and can improve video subscribers' quality of experience.

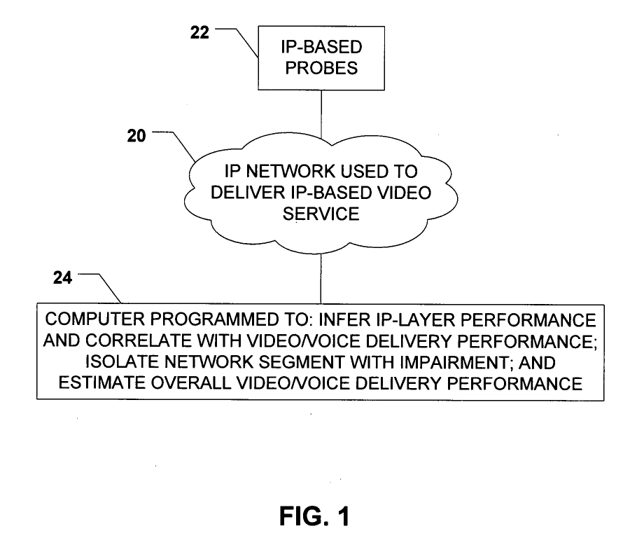

FIG. 1 is a block diagram of a system for determining delivery path performance in an IP network 20 used to deliver an IP-based video service, and optionally one or more other network services such as voice, audio and/or data services. A plurality of IP-based probes 22 are positioned at particular locations in the IP network 22. The IP-based probes 22 introduce probing traffic to perform IP path probing of the IP network 20. The probing traffic usually causes extra overhead to the IP network 20 which, if undesirably large in volume, undesirably impacts normal video/audio delivery performance and/or causes an inaccurate reflection of existing network delivery performance. To address the aforementioned issues, each of the IP-based probes 22 has a particular probing type and appropriate location in the EP network 20, each probe-based test is appropriately performed at an appropriate time (e.g. a probe-based test may use a probing frequency that adapts to changing conditions), and results of the probing are correlated to trouble tickets in order to perform a root-cause analysis to isolate any troubles in the IP network 20.

Degradation of video delivery path performance may cause an impairment of video service quality. For example, packet loss can cause any combination of: unavailable video frames to display, video service glitches and/or pixilation. Further for example, large latency and jitter values can cause video decoder buffer overflow or underflow, which in turn can cause time synchronization issues or other issues. Video service quality impairments may be caused by encoder network issues, long distance link failures, routing disruptions, traffic congestions, router/switch mis-configurations, impairment of a very-high-data-rate digital subscriber line (VDSL) network and/or a home network, overloading issues with routers or residential gateways, set-top box (STB) operation issues, or any combination thereof.

A computer 24 cooperates with the IP-based probes 22 to detect network impairments in the IP network 20, isolate troubles in the IP network 20, and act to mitigate the impairments in the IP network 20. In an embodiment, the computer 24 is programmed to: (a) infer IP-layer performance and correlate the performance with video/voice delivery performance, (b) isolate a network segment with a detected impairment, and (c) estimate an overall video/voice delivery performance. Detecting network impairments, performing trouble isolation, and quickly mitigating the impairments is of particular interest when the video delivery network, such as the IP network 20, comprises many network elements (e.g. thousands or tens of thousands of network elements).

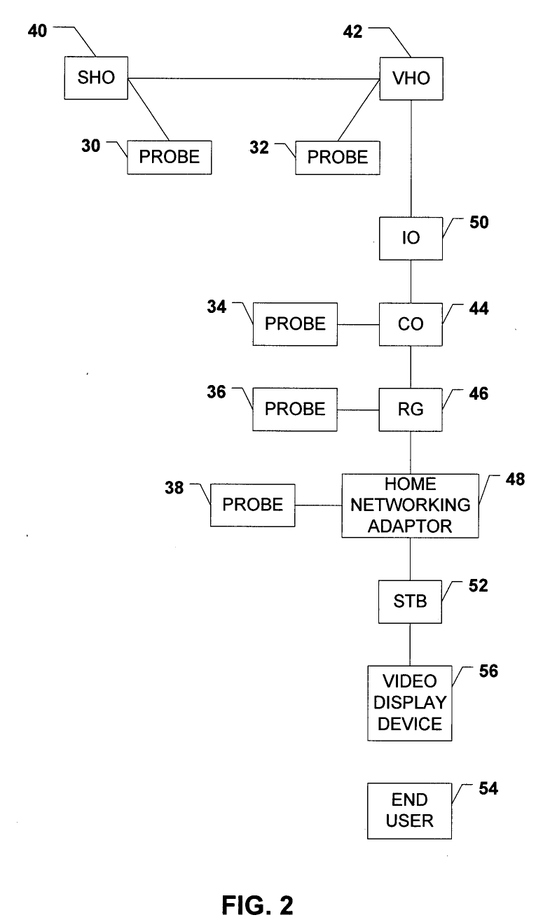

FIG. 2 is a block diagram of an embodiment of placement of the IP-based probes 22 in an embodiment of the IP network 20. The IP-based probes 22 comprise a plurality of network performance probing devices including probes 30, 32, 34, 36 and 38. The probe 30 is deployed at and connected to a super hub office (SHO) 40. The probe 32 is deployed at and connected to a video hub office (VHO) 42. The probe 34 is deployed at and connected to a central office (CO) 44. The probe 36 is deployed at and connected to a residential gateway (RG) 46. The probe 38 is deployed at and connected to a home networking adaptor 48 such as a Home Phoneline Networking Alliance (HPNA) adaptor. In this embodiment, the SHO 40 serves one or more video hub offices, including the VHO 42, to provide the video service. Further in this embodiment, the VHO 42 and the CO 44 communicate via an intermediate office (IO) 50. A set-top box (STB) 52 is coupled to the home networking adaptor 48 at a premise of an end user 54 of the video service. The STB 52 is connected to a video display device 56 to display video programs from the video service to the end user 54.

The probes 30, 32, 34, 36 and 38 are used to perform various probing tests. The probing tests may include IP-based multicast tests and/or unicast tests. Examples of the unicast tests include, but are not limited to, user datagram protocol (UDP) tests and packet internet groper (PING) tests. The IP-based multicast tests, which provide a lightweight approach to measure most IP network segment performance, are used to monitor the linear programming delivery performance of the IP network 20. If IP-based video delivery is on top of IP-based multicast, the multicast-based probe test can be set up with a similar QoS level to best monitor linear programming video delivery performance. The unicast tests (e.g. UDP and/or PING tests) can be set up at selected locations and segments at selected times to confirm results of the multicast tests and to perform trouble isolation and segmentation.

For example, consider a scenario in which both of the probes 36 and 38 receive multicast traffic based on probing traffic originated from the VHO 42, but the probe 38 captures significant packet loss while the probe 36 does not capture significant packet loss. In the aforementioned scenario, a conclusion can be drawn that a home network segment between the RG 46 and the home networking adaptor 48 is contributing to the packet loss. To further confirm the aforementioned conclusion, two-way UDP-based tests can be performed between the probes 36 and 38 to monitor the home network performance. If the two-way UDP-based tests detect a packet loss between the RG 46 and the home networking adaptor 48, an impairment of the home network segment is inferred.

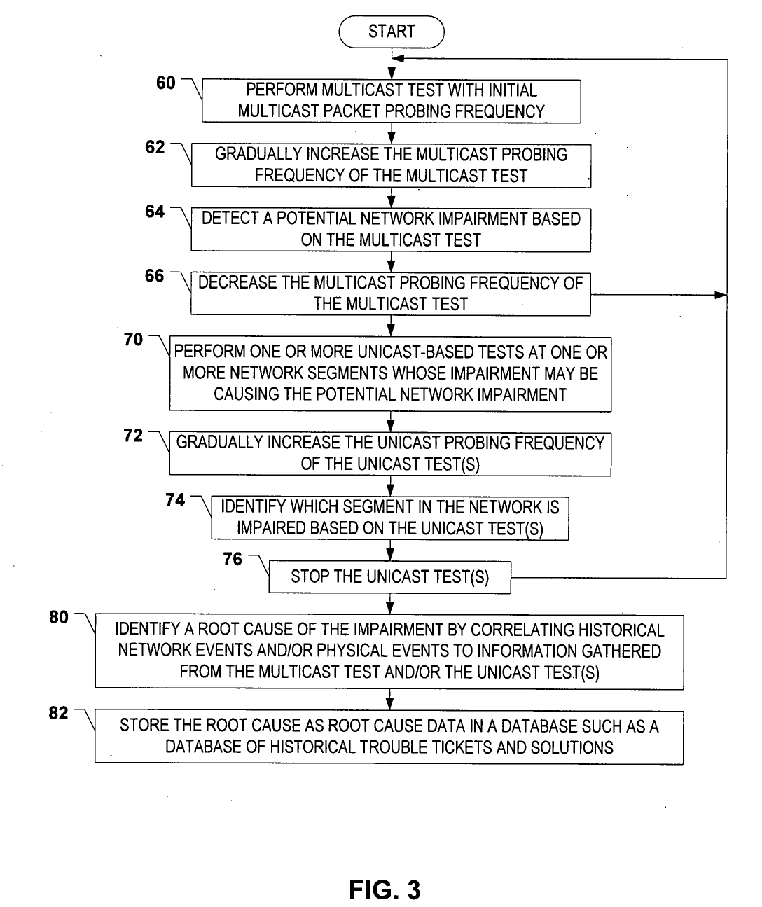

FIG. 3 is a flow chart of an embodiment of a method of testing the IP network using multicast and unicast tests. The method can be used to detect and isolate trouble in the IP network. The method also can be used to perform trouble isolation during video quality lab testing (e.g. to perform trouble isolation and to locate Internet Group Management Protocol (IGMP) setup issues).

As indicated by block 60, the method comprises performing a multicast test with an initial multicast packet probing frequency. The initial multicast packet probing frequency is a relatively low value. As indicated by block 62, the method comprises gradually increasing the multicast probing frequency of the multicast test.

As indicated by block 64, the method comprises detecting a potential network impairment based on the multicast test. Based on detecting the potential network impairment, the method comprises decreasing the multicast probing frequency (as indicated by block 66) and performing one or more unicast-based tests at one or more network segments whose impairment may be causing the potential network impairment (as indicated by block 70). Regarding block 66, the multicast probing frequency may be decreased back to the initial multicast packet probing frequency. Regarding block 70, the one or more unicast-based tests may comprise UDP and/or PING tests performed between various network elements. For example, a unicast-based test may be performed between the home networking adaptor 48 and the RG 46, or between the RG 46 and the CO 44, or between the CO 44 and the VHO 42. The one or more segments selected for performing the unicast tests may be based on historical network data, such from a historical trouble tickets and solutions database. The one or more unicast-based tests are performed at an initial unicast probing frequency. As indicated by block 72, the method comprises gradually increasing the unicast probing frequency.

As indicated by block 74, the method comprises identifying which one or more segments in the IP network 20 are impaired based on the one or more unicast-based tests. As indicated by block 76, the method comprises stopping the one or more unicast-based tests after either an impaired segment is identified or enough information is gathered to identify the impaired segment. As indicated by block 80, the method comprises identifying a root cause of the impairment. The root cause can be identified by correlating historical network events and/or physical events to the information gathered from the multicast and/or unicast tests. As indicated by block 82, the method comprises storing the root cause as root cause data in a database such as a database of historical trouble tickets and solutions.

Flow of the method is directed back to block 60 to repeat the aforementioned acts to detect subsequent network impairments. The previously-stored root cause data can be used to identify a subsequent root cause of a subsequently-detected impairment of the IP network 20.

The computer 24 in FIG. 1 may cause a display device and/or hard copy device (e.g. a printer) to display and/or print results of the tests performed in FIG. 3. The results of the tests may be displayed and/or printed as graphs showing a number of packets lost versus time. The graphs may have a y-axis that represents a number of packets lost in a time interval, and an x-axis that represents each time interval over a time period. The time intervals and the time period may be any length, in general. In some cases, the time period may be a single day or multiple days (e.g. five days). By viewing the graphs, individuals can see when one or more devices experienced packet loss. For example, packet loss may be due to an RG being reinitialized, which in turn causes packets to be unavailable for a duration of tens or hundreds of seconds, for example.

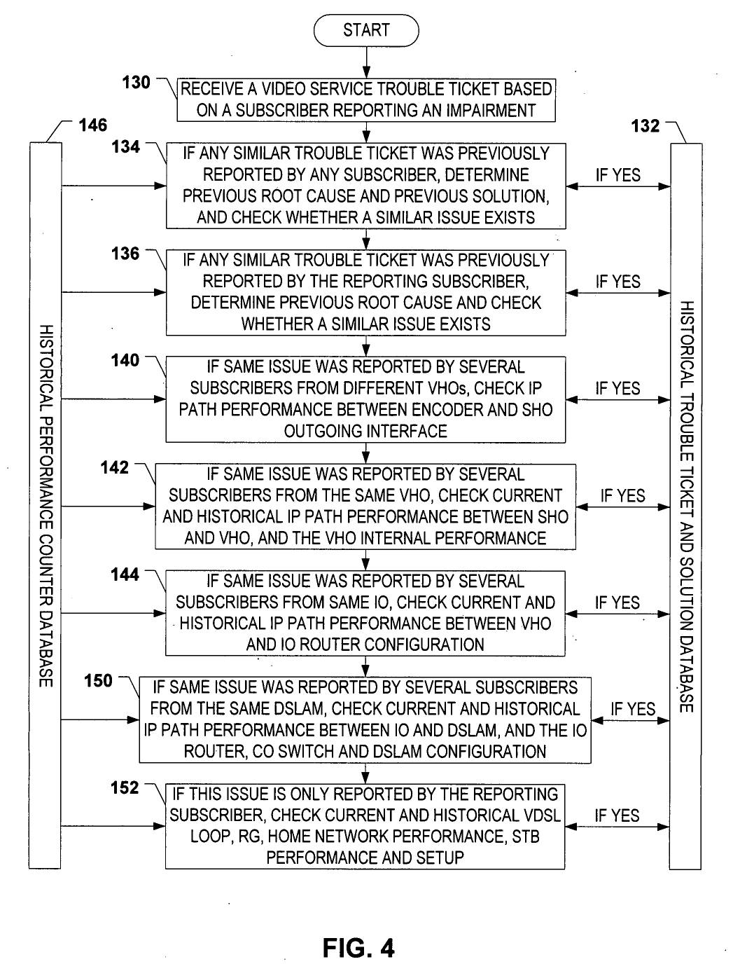

FIG. 4 is a flow chart of an embodiment of a method of performing trouble isolation based on probing results. The method provides a divide-and-conquer approach that is well-suited to multicast-based video delivery in which multiple STBs have video delivery paths that share common segments at some network points. The method also contemplates that many network troubles are caused by similar issues, and that historical events sometimes repeat. The method can be directed by the computer 24 in FIG. 1.

As indicated by block 130, the method comprises receiving a video service trouble ticket or an alternative report of an end user (e.g. a subscriber) of a video service reporting an issue with the video service. The video service trouble ticket is generated in response to a subscriber reporting that video service and/or the IP network 20 is impaired. After the video service trouble ticket is received (or after a service impairment is otherwise reported), a database 132 of historical trouble tickets and solutions is accessed to check whether similar issues were previously reported. Based on statistical estimation, common root causes are analyzed and examined to determine whether any issue needs to be resolved based on previous knowledge.

The statistical estimation may be based on both a space dimension and a time dimension. For the space dimension, the statistical estimation is performed for multiple subscribers (e.g. including subscribers other than the reporting subscriber, such as across all subscribers) and also for a single subscriber (e.g. the reporting subscriber). For the time dimension, the statistical estimation is performed across different time intervals such as daytime/nighttime, and recent/old events. By correlating the historical data, e.g. correlating trouble tickets reported for similar times by different subscribers, troubles in the IP network 20 can be isolated and particular network segment(s) which are the root cause can be determined. Examples of root causes for the event indicated by the trouble ticket include, but are not limited to, impairments of an encoder network, the SHO, the VHO, the IO, the VDSL loop, the home network, or the STB. An embodiment of a process to gradually segment potential problems and perform a root cause analysis is as follows.

As indicated by block 134, the method comprises determining if any similar trouble ticket was previously reported by any subscriber. If yes, the database 132 is accessed to determine what was the root cause and solution for the previous trouble ticket. The IP network 20 is examined to determine if the root cause for the previous trouble ticket is also the root cause for the current trouble ticket.

As indicated by block 136, the method comprises determining if any similar trouble ticket was previously reported by the reporting subscriber. If yes, the database 132 is accessed to determine what was the root cause and solution for the previous trouble ticket. The IP network 20 is examined to determine if the root cause for the previous trouble ticket is also the root cause for the current trouble ticket.

As indicated by block 140, the method comprises determining if the same issue was reported by several subscribers from different VHOs. The same issue is deemed to be reported by several subscribers from different VHOs if the number of subscribers from different VHOs who reported the same issue is greater than or equal to a first threshold. If yes, the method comprises testing or otherwise checking a performance of an IP path between an encoder and an outgoing interface of the SHO.

As indicated by block 142, the method comprises determining if the same issue was reported by several subscribers from the same VHO as the reporting subscriber. The same issue is deemed to be reported by several subscribers from the same VHO if the number of subscribers from the same VHO who reported the same issue is greater than or equal to a second threshold. If yes, the method comprises testing or otherwise checking a performance of an IP path between the SHO and the VHO, and an internal performance of the VHO.

As indicated by block 144, the method comprises determining if the same issue was reported by several subscribers from the same IO as the reporting subscriber. The same issue is deemed to be reported by several subscribers from the same IO if the number of subscribers from the same IO who reported the same issue is greater than or equal to a third threshold. If yes, method comprises testing or otherwise checking the current and historical IP path performance between the VHO and the IO, and the IO router configuration. A database 146 stores the historical IP path performance between the VHO and the IO and other historical performance information. The current and historical performances can be compared to determine if the path between the VHO and the IO is impaired.

As indicated by block 150, the method comprises determining if the same issue was reported by several subscribers from the same digital subscriber line access multiplexer (DSLAM) as the reporting subscriber. The same issue is deemed to be reported by several subscribers from the same DSLAM if the number of subscribers from the same DSLAM who reported the same issue is greater than or equal to a fourth threshold. If yes, the method comprises testing or otherwise checking current and historical IP path performance between the IO and the DSLAM, the IO router, the CO switch, and the DSLAM configuration. The database 146 stores the historical IP path performance between the IO and the DSLAM and other historical performance information. The current and historical performances can be compared to determine if the path between the IO and the DSLAM is impaired.

As indicated by block 152, the method comprises determining if the issue is reported only by one subscriber, namely the presently-reporting subscriber. If yes, the method comprises testing or otherwise checking current and historical performance of the VDSL loop, the RG, the home network, and the performance and setup of the STB. The database 146 stores the historical performance of the VDSL loop and other historical performance information. The current and historical performances can be compared to determine if the VDSL loop is impaired.

For any of the above acts, various troubleshooting methods can be used to verify a problem. Examples of the troubleshooting methods include, but are not limited to, testing using IP-based probes, checking VDSL/home network noise, checking open shortest path first (OSPF) or border gateway protocol (BGP) configuration, and verifying an IGMP routing configuration.

If an issue is identified based on any of the above acts, the method comprises updating the database 132 of historical trouble tickets and solutions to include the new findings. The new findings, including a root cause, can be used to better identify root causes of subsequently-reported video service issues. As more instances and cases are added to the database 132, the ability to troubleshoot subsequent problems improves.

Any of the above testing acts may comprise automated testing, manual testing, or a combination of automated and manual testing. Any of the above testing acts may be triggered or otherwise initiated by a computer, such as the computer 24. The computer may trigger or otherwise initiate the automated testing and/or manual testing upon determining that an associated condition is met.

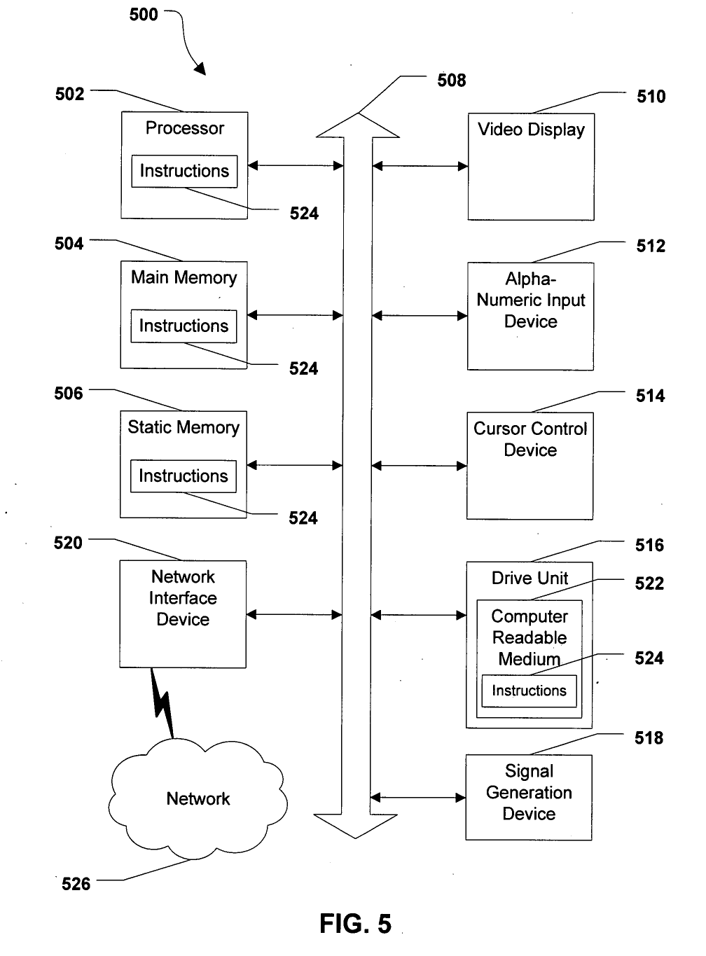

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506, that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of testing an Internet Protocol (IP) network, the method comprising:
performing a multicast test of the IP network with an initial multicast probing frequency;
increasing the multicast probing frequency of the multicast test;
detecting an impairment of the IP network based on the multicast test;
based on said detecting the impairment, performing a unicast test at one or more segments of the IP network; and
based on the unicast test, identifying an impaired segment of the IP network.

2. The method of claim 1 wherein said performing the unicast test comprises performing the unicast test with an initial unicast probing frequency, the method further comprising increasing the unicast probing frequency of the unicast test.

3. The method of claim 1 further comprising stopping the unicast test after said identifying the impaired segment of the IP network.

4. The method of claim 1 wherein the unicast test comprises a user datagram protocol (UDP) test.

5. The method of claim 1 wherein the unicast test comprises a packet internet groper (PING) test.

6. The method of claim 1 wherein the one or more segments of the IP network selected for performing the unicast test is based on historical network data.

7. The method of claim 1 further comprising identifying a root cause of the impairment based on a result of the unicast test.

8. The method of claim 7 wherein said identifying the root cause is by correlating at least one historical network event to the result of the unicast test.

9. The method of claim 7 further comprising:
storing the root cause as root cause data in a database of historical trouble tickets and solutions.

10. The method of claim 9 further comprising identifying a subsequent root cause of a subsequent impairment of the IP network by retrieving the root cause data from the database.

11. The method of claim 1 further comprising:
based on said detecting the impairment, decreasing the multicast probing frequency.

12. A computer-readable storage medium encoded with a computer program to cause a computer and at least one probe to test an Internet Protocol (IP) network by:
performing a multicast test of the IP network with an initial multicast probing frequency;
increasing the multicast probing frequency of the multicast test;
detecting an impairment of the IP network based on the multicast test;
based on said detecting the impairment, performing a unicast test at one or more segments of the IP network; and
based on the unicast test, identifying an impaired segment of the IP network.

13. The computer-readable storage medium of claim 12 wherein the computer program is cause the computer and the at least one probe to test the IP network by:
based on said detecting the impairment, decreasing the multicast probing frequency.

14. A system to test an Internet Protocol (IP) network, the system comprising:
at least one probe; and
a computer which cooperates with the at least one probe to: perform a multicast test of the IP network with an initial multicast probing frequency, increase the multicast probing frequency of the multicast test, detect an impairment of the IP network based on the multicast test, perform a unicast test at one or more segments of the IP network upon detecting the impairment, and identify an impaired segment of the IP network based on the unicast test.

15. The system of claim 14 wherein the computer cooperates with the at least one probe to decrease the multicast probing frequency upon detecting the impairment.

16. A method comprising:
receiving a report of an end user of a video service reporting an issue with the video service;
determining that a number of other end users from different video hub offices (VHOs) also reported the issue, the number of other end users being greater than or equal to a threshold; and
based on said determining, initiating testing a performance of a path between an encoder and an outgoing interface of a super hub office (SHO) used to provide the video service.

17. A method comprising:
receiving a report of an end user of a video service reporting an issue with the video service;
determining that a number of other end users having a same video hub office (VHO) as the end user also reported the issue, the number of other end users being greater than or equal to a threshold; and
based on said determining, initiating testing a performance of a path between a super hub office (SHO) used to provide the video service and the VHO.

18. The method of claim 17 further comprising:
based on said determining, initiating testing an internal performance of the VHO.

19. A method comprising:
receiving a report of an end user of a video service reporting an issue with the video service;
determining that a number of other end users having a same intermediate office (IO) as the end user also reported the issue, the number of other end users being greater than or equal to a threshold; and
based on said determining, initiating testing a current performance of a path between a video hub office (VHO) and the IO.

20. The method of claim 19 further comprising:
based on said determining, initiating testing a router configuration of the IO.

21. The method of claim 19 further comprising:
based on said determining, retrieving historical performance information for the path from a database, and comparing the historical performance information to the current performance.

22. A method comprising:
receiving a report of an end user of a video service reporting an issue with the video service;
determining that a number of other end users having a same digital subscriber line access multiplexer (DSLAM) as the end user also reported the issue, the number of other end users being greater than or equal to a threshold; and
based on said determining, initiating testing a current performance of a path between an intermediate office (IO) and the DSLAM.

23. The method of claim 22 further comprising:
based on said determining, initiating testing a router of the IO, a switch of a central office (CO), and a configuration of the DSLAM.

24. The method of claim 22 further comprising:
based on said determining, retrieving historical performance information for the path from a database, and comparing the historical performance information to the current performance.
